(19) United States
(12) Patent Application Publication
(10) Pub. No.: US 2013/0060556 A1
(43) Pub. Date: Mar. 7, 2013

(54) SYSTEMS AND METHODS OF RUNTIME SYSTEM FUNCTION ACCELERATION FOR CMP DESIGN

(71) Applicant: Guang R. GAO, Newark, DE (US)

(72) Inventor: Guang R. GAO, Newark, DE (US)

(73) Assignee: ET International, Inc., Newark, DE (US)

(21) Appl. No.: 13/548,805

(22) Filed: Jul. 13, 2012

Related U.S. Application Data
(60) Provisional application No. 61/508,743, filed on Jul. 18, 2011.

(51) Int. Cl. G06G 7/62

(52) U.S. Cl. 703/21

(57) ABSTRACT

A chip-level multiprocessing system may be designed for accelerated implementation of a specified user computing application. The application may be converted to a parallel program representation with explicit runtime functions denoted. One or more of the explicit runtime functions may be identified for implementation in the form of a specialized intellectual property core (IP-core). The remaining portions of the application may then be implemented in a further IP-core, and the IP-cores may be interconnected to implement the user computing application.

### CROSS-REFERENCE TO RELATED APPLICATIONS

This application is a non-provisional application claiming priority to U.S. Provisional Patent Application No. 61/508,743, filed on Jul. 18, 2011, which is incorporated by reference herein.

### FIELD

Various embodiments of the invention may relate to multi-processor intellectual property (IP) core design.

### BACKGROUND

The existing methodology of chip-level multi-processing (CMP) based runtime system function is mostly through optimization on software implementation. Here, a base assumption is that the architecture model and major implementation of a CMP design has been fixed. The task of runtime system function implementation and optimization are presented solely as a software job.

Another approach, hybrid-core technology (e.g. by Convey Computer), provides application-specific acceleration for large HPC-class problems using dynamically loadable personalities. Extensions to the x86 instruction set “personalities” are implemented in the hardware to optimize performance of specific portions of an application. In particular, Convey's hybrid-core solution tightly integrates commercial, off-the-shelf hardware, namely, Intel® Xeon® processors and Xilinx® Field Programmable Gate. Arrays (FPGAs).

However, one may wish to take more generic approaches to such system design that may not necessarily be linked to an assumption of a specific hardware model or instruction set, as in the above approaches.

### BRIEF SUMMARY OF EMBODIMENTS OF THE INVENTION

Embodiments of the invention may directed to a method to create a multiprocessor IP-core design process that may permit runtime system functions to be implemented by dedicated hardware IP-cores, which may permit acceleration. Embodiments of the invention may also be directed to a method to design a system software stack that may compile applications without extensive source code modifications to exploit the tradeoffs of the hardware acceleration of certain runtime system functions. Various embodiments may be implemented in hardware, software, firmware, or combinations thereof.

### BRIEF DESCRIPTION OF THE DRAWINGS

Various embodiments of the invention will now be discussed in further detail in conjunction with the attached drawings, in which:

FIG. 1 presents a conceptual diagram according to various embodiments of the invention; and

FIG. 2 presents an exemplary system that may be used to implement some or all of various embodiments of the invention.

### DETAILED DESCRIPTION OF VARIOUS EMBODIMENTS

Various embodiments of the invention may include:
(1) A generic CMP (Chip-level Multiprocessing) architecture IP-core in which the component processors (cores) may adapt different instruction-set architecture (ISA) IP-core designs (e.g., ARM cores, etc.), which may result in different style multi-core architecture IP-core designs;
(2) The generic CMP IP-core may be extended by utilizing a number of architecture features for performance enhancement. Each of such features may be realized by software (e.g., but not necessarily limited to, through runtime software functions) or dedicated hardware support;
(3) Such hardware support may be realized through a custom-designed IP-core (e.g., RSAU —Runtime System Acceleration Unit) that may implement specialized (e.g., commonly used and/or application-specific) runtime system functions in hardware;
(4) A method (process) may tailor and integrate the RSAU into the generic CMP IP-core design and may produce an optimized CMP IP-core design; and
(5) A method to design a system software stack may compile existing applications without extensive source code modifications to exploit the tradeoffs of employing the hardware acceleration of certain runtime system functions.

Various embodiments of the invention may have one or more of the following features:
A generic multiprocessor IP-core design in which features of a particular uniprocessor ISA IP-core may be substituted by other available industry standard uniprocessor IP-cores (such as ARM, Adapteva, etc.);
A number of the architecture features of above multiprocessor architecture IP-core design—e.g., for performance and security enhancement—may include an option that respective ones of such features may be realized by software through runtime software functions or by dedicated hardware implementations through IP-cores;
A custom designed IP-core (RSAU) that may implement these architecture features through dedicated hardware functions for performance enhancement;
A method to integrate RSAU into the generic multiprocessor architecture IP-core; and
A method to design a system software stack that may compile existing applications without extensive source code modifications to exploit the tradeoffs of employing the hardware acceleration of certain runtime system functions.

In contrast with existing technologies, embodiments of the present invention may begin with an assumption that a hardware based “generic” CMP architecture design is available at the beginning of software/hardware co-design process to accelerate the selected runtime system functions. The performance critical runtime system functions that need hardware support for acceleration may be identified through analysis and mapped to RSAUs to be included as an extension of the generic CMP architecture design. An iterative process may be applied to the analysis-map-evaluation cycle until final design goal of the runtime system function acceleration is achieved.

Furthermore, embodiments of the present invention may not be locked into a specific instruction set architecture for processing cores. Additionally, RSAU IP-cores may be implemented on the same chip of a CMP without using FPGAs.

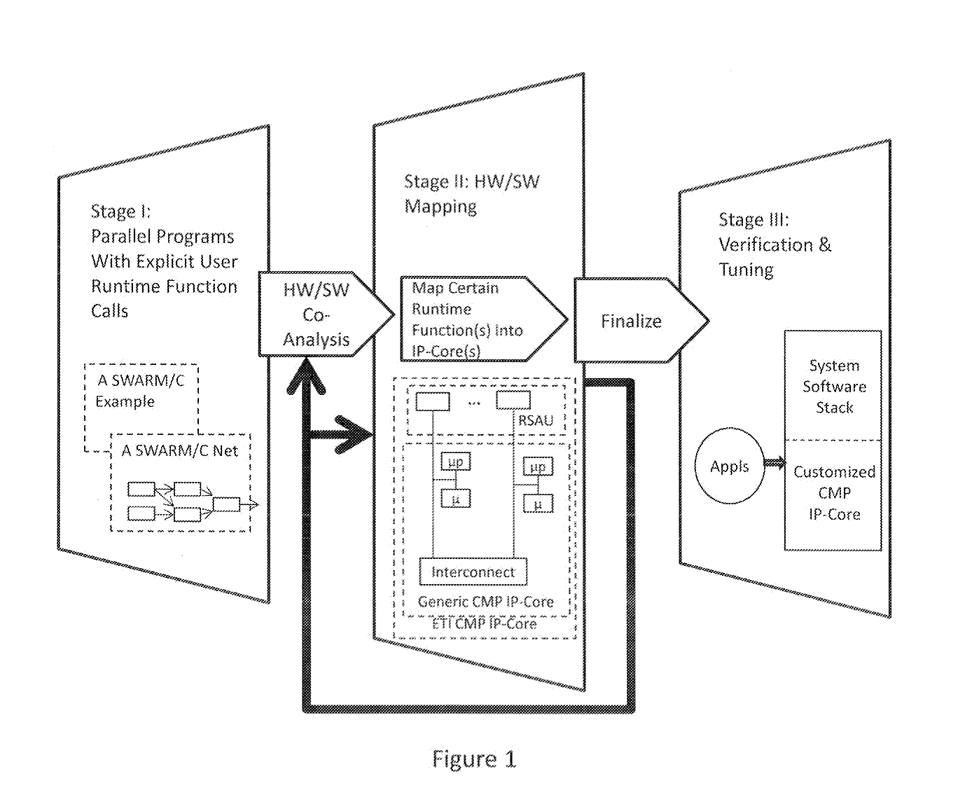

In FIG. 1, which shows a conceptual diagram of embodiments of the invention, it is assumed that a customer (user) may utilize the CMP design method and HW/SW platform, such as, but not necessarily limited to, that of ET International, Inc. (ETD, in three stages as described below.
Stage I: Under various embodiments of the invention, in this stage a user application (e.g., some computing task to be implemented) may be converted into a parallel program representation where runtime functions may be explicitly denoted. FIG. 1 depicts the use of ETI proprietary SWARM/C as an example, to which the invention is not limited. The SWARM/C code may be translated into SWARM/C net, where dependencies and resource constraints may be made explicit, and the SWARM runtime functions may be introduced as may be necessary.
Stage II: In various embodiments of the invention, in this stage, the HW/SW mapping method may identify certain original runtime system functions as represented in the parallel program representation (e.g., the SWARM/C net above) as being candidates for possible implementation by a hardware IP-core. An analysis step may be performed to examine each such candidate and to determine if a subset exists that should be an initially designated target for hardware implementation. Then, a code generator, for example, ETI's CMP-Codegen (to which the invention is not limited), may compile the CMP IR (Intermediate Representation—such as, but not limited to, SWARM Net/C) into machine level executable code that may be able to run on the CMP IP-core with the runtime system functions in the above subset to be realized through the RSAU IP-cores. A simulation may provide an estimate of a resulting design for this application. If design goals arc not met, then Stage II may be re-invoked, and additional runtime functions may be added to the set of candidates for hardware implementation. Then, the process may be repeated until the design goals are finally met (or are met to within some predetermined tolerance).
Stage III: In embodiments-of the invention, in this stage, a “verification and tuning” method may perform a final production of the customized CMP IP-core and the system software stack. A verification may be performed to verify the functionality of the design, while the design may be further tuned by performing minor adjustments for the final design.

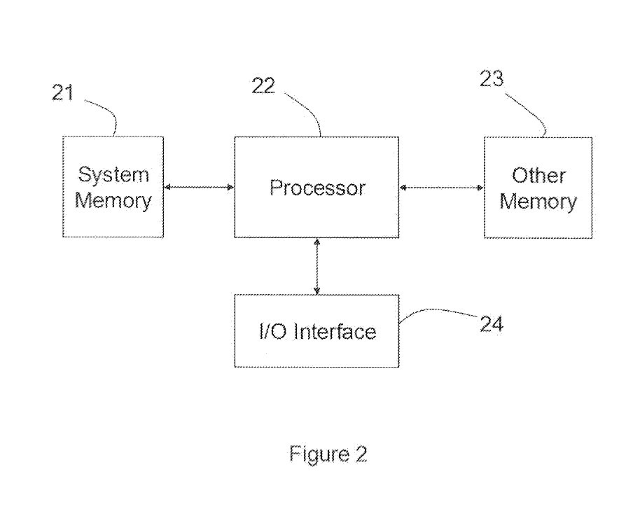

Various embodiments of the invention may comprise hardware, software, and/or firmware. FIG. 2 shows an exemplary system that may be used to implement various forms and/or portions of embodiments of the invention. Such a computing system may include one or more processors 22, which may be coupled to one or more system memories 21. Such system memory 21 may include, for example, RAM, ROM, or other such machine-readable media, and system memory 21 may be used to incorporate, for example, a basic I/O system (BIOS), an operating system, instructions for execution by processor 22, etc. The system may also include further memory 23, such as additional RAM, ROM, hard disk drives, or other processor-readable media. Processor 22 may also be coupled to at least one input/output (I/O) interface 24. I/O interface 24 may include one or more user interfaces, as well as readers for various types of storage media and/or connections to one or more communication networks (e.g. communication interfaces and/or modems), from which, for example, software code may be obtained. Such a computing system may, for example, be used as a platform on which to run translation software and/or to control, house, or interface with an emulation system. Furthermore, other . devices/media, such as FPGAs, may also be attached to and interact with the system.

It will be appreciated by persons skilled in the art that the present invention is not limited by what has been particularly shown and described hereinabove. Rather the scope of the present invention includes both combinations and sub-combinations of various features described hereinabove as well as modifications and variations which would occur to persons skilled in the art upon reading the foregoing description and which are not in the prior art.

I claim:

1. A method of designing a chip-level multiprocessing system, the method comprising;
converting a specified user application into a parallel program representation having one or more explicitly-denoted runtime functions;
identifying at least one of the one or more explicitly-denoted runtime functions of the parallel program representation for implementation in the form of a specialized hardware intellectual property core (IP-core) for a particular runtime function;
implementing the at least one of the one or more explicitly-denoted runtime functions in the form of a corresponding at least one runtime system IP-core hardware unit;
generating machine-level executable code to implement portions of the user application not implemented in the at least one runtime system IP-core hardware unit; and
using the machine-level executable code to generate a further IP-core hardware unit configured to be coupled to the at least one specialized hardware IP-core to implement the user application in the form of a chip-level multiprocessing system.

2. The method of claim 1, further comprising performing at least one simulation prior to implementing the at least one of the one or more explicitly-denoted runtime functions in at least one runtime system IP-core hardware unit and prior to using the machine-level executable code to generate a further IP-core hardware unit.

3. The method of claim 2, wherein at least one result of the at least one simulation is compared to at least one design goal, and if the at least one result does not satisfy the at least one design goal, repeating said identifying and said generating.

4. The method of claim 1, further comprising verifying and tuning the chip-level multiprocessing system.

5. A computer-readable medium containing executable instructions that, upon execution, implement operations corresponding to the method of claim 1.

6. A chip-level multiprocessing system comprising:
one or more specialized intellectual property core (IP-core) hardware units configured to implement one or more explicitly-denoted runtime functions identified in a parallel program representation of a specified user application;
a further IP-core hardware unit configured to implement portions of the user application not implemented in the one or more specialized IP-core hardware units; and
interconnections between the one or more specialized IP-core hardware units and the further IP-core hardware unit configured to enable the one or more specialized IP-core hardware units and the further IP-core hardware unit to implement the user application in the form of a chip-level multiprocessing system.

7. The chip-level multiprocessing system of claim 6, further comprising at least one microprocessor unit.
